(19) United States
(12) Patent Application Publication
(10) Pub. No.: US 2002/0186301 A1
(43) Pub. Date: Dec. 12, 2002

(54) Method of the cooperation service, contents receiver and attraction system

(76) Inventor: Takashi Hasegawa, Tokyo (JP)

Correspondence Address: Mattingly, Stanger & Malur, P.C., Suite 370, 1800 Diagonal Road, Alexandria, VA, 22314, US

(21) Appl. No.: 10/073,989

(22) Filed: Feb. 14, 2002

(30) Foreign Application Priority Data
Jun. 11, 2001 (JP) 2001-175020

(51) Int. Cl. H04N 7/18

(52) U.S. Cl. 348/207.99; 348/143

(57) ABSTRACT

There are provided a method of cooperation service with attraction and seeing and listening of contents, a contents receiver and an attraction system, which have the effect for inducing a visitor to an attraction to see and listen to contents. A park image which includes an image of a customer who visits an attraction park is taken by a camera of an attraction system, so that the park image is recorded onto a portable recording medium. A receiver receives contents related to the attraction delivered from a broadcaster and reads the park image recorded onto the recording medium which is then inserted into the contents.

### BACKGROUND OF THE INVENTION

The present invention relates to a method of cooperation service with attraction and seeing and listening of contents, which associates a service in an attraction of a theme park and the like with seeing and listening of contents (images or sounds).

In Japan, various theme parks have appeared and have prepared some popular attractions (for example, a space adventure experience, a large-scale roller coaster, and so on) in a manner such that people line up and wait. In many of such attractions, people take and enjoy a vehicle (hereinafter, referred to as a “ride”) . As a privilege service in this case, for example, there is a service which sells a photo of an audience taking a ride and enjoying an attraction in a theme park after he/she uses the attraction.

Contents (images or sounds) delivered via a transmission path of television broadcasting or the Internet, or contents supplied by a medium such as a DVD (Digital Versatile Disc) show an example in which contents related to the above-mentioned attraction can become a popular program. There is an example in which delivered contents (for example, an animation film using dinosaurs as material therefor) become popular to be material for the attraction.

### SUMMARY OF THE INVENTION

The above-mentioned photo supply service does not have the effect for inducing a customer to separately see and listen to contents related to a used attraction.

An object of the present invention is to provide a method of cooperation service with attraction and seeing and listening of contents, a contents receiver and an attraction system, which have the effect for inducing a visitor to an attraction to see and listen to contents.

To achieve the foregoing purpose, a method of cooperation service with attraction and seeing and listening of contents according to the present invention includes: taking a park image to which a customer visiting an attraction park is related; capturing the taken park image into a receiver; and inserting the park image into contents related to the attraction, the contents being supplied for seeing and listening by using the receiver.

The receiver inserts the customer-related park image into a story of the contents so as to create an image in which the customer takes part in the story. Such supply of an image in which a customer takes part is a privilege to a customer visiting an attraction park, thereby obtaining the effect for inducing seeing and listening of contents.

These and other objects, features and advantages of the present invention will become more apparent in view of the following detailed description of the preferred embodiments in conjunction with accompanying drawings.

### BRIEF DESCRIPTION OF THE DRAWINGS

FIG. 1 is a basic block diagram of assistance in explaining an embodiment of a method of cooperation service with attraction and seeing and listening of contents according to the present invention;

FIG. 2 is a block diagram of assistance in explaining an embodiment of an attraction system according to the present invention;

FIG. 3 is a flowchart of assistance in explaining an embodiment of the method of cooperation service with attraction and seeing and listening of contents according to the present invention;

FIG. 4 is a block diagram of assistance in explaining another embodiment of the attraction system according to the present invention;

FIG. 5 is a flowchart of assistance in explaining another embodiment of the method of cooperation service with attraction and seeing and listening of contents according to the present invention;

FIG. 6 is a flowchart of assistance in explaining a further embodiment of the method of cooperation service with attraction and seeing and listening of contents according to the present invention;

FIG. 7 is a diagram of assistance in explaining an example of picture/video data related information to be delivered;

FIG. 8 is a block diagram of assistance in explaining an embodiment of a receiver according to the present invention;

FIG. 9 is a flowchart of assistance in explaining an example of a picture/video data reception processing;

FIG. 10 a flowchart of assistance in explaining an example of a picture/video data selection and purchasing processing;

FIG. 11 is a diagram of assistance in explaining an example of contents and related data to be delivered;

FIG. 12 is a diagram of assistance in explaining an example of stored contents related data; and

FIG. 13 is a flowchart of assistance in explaining an example of a picture/video data insertion processing into contents.

### DESCRIPTION OF THE PREFERRED EMBODIMENTS

A method of cooperation service with attraction and seeing and listening of contents, a contents receiver and an attraction system according to the present invention will be described hereinbelow in greater detail with reference to embodiments shown in some drawings.

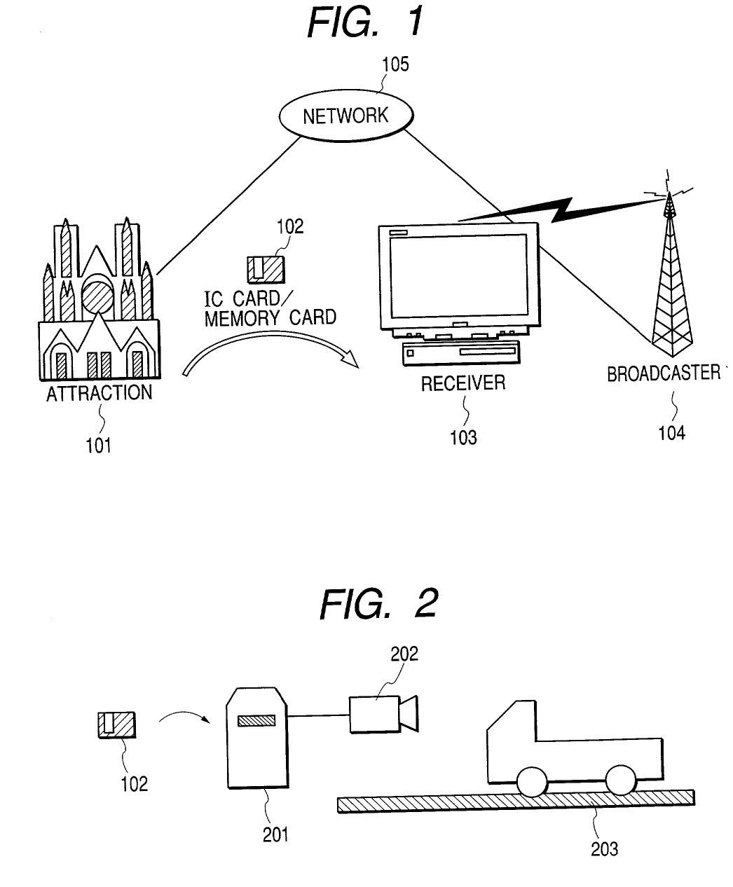

First, an example of an overview for carrying out this embodiment will be described using FIG. 1. The overall has portable recording medium 102 (hereinafter, referred to as “removable medium”) such as an IC card or a memory card for recording a customer ID (identifier) for specifying a customer, an attraction system 101, which is an attraction system for executing an attraction, for taking a park image related to the customer and recording it onto the removable medium 102, a broadcaster 104 for delivering contents related to the attraction, and a contents receiver 103 for receiving the contents delivered from the broadcaster 104, reading the park image written into the medium 102 and inserting the park image into the received contents. The receiver 103 specifies a customer by reading private information from the removable medium 102. The customer-related park image is mainly a still image or a moving image which includes an image of a customer in a park.

In FIG. 1, contents are broadcasted from the broadcaster 104 via an electric wave transmission path. The contents, however, may be delivered via a transmission path by a broadband network such as the Internet, and be supplied by a medium such as a DVD.

In some services, the attraction system 101 and the broadcaster 104 can be connected by a network 105, so that a taken park image is transmitted via the network 105 to the broadcaster 104. In this case, the park image is delivered to the receiver 103 by the broadcaster 104, not by the removable medium 102.

Further, the broadcaster 104 mainly performs customer management for audiences and a payment processing related to seeing and listening of contents. However, these can be done in a section different from the broadcaster 104.

A first example of the attraction system 101 in this embodiment will be described using FIG. 2. The attraction system 101 has a camera 202 for taking a park image, an information writer 201 for recording the taken park image and picture/video data onto the removable medium 102, and a ride 203 that a customer takes. The camera 202 typically has one or more video cameras. The attraction system 101 has an attraction device for executing an attraction, but the illustration thereof is omitted.

Subsequently, a first example of a service method in this embodiment will be described using FIGS. 1 to 3. In this method, the removable medium 102 for previously recording ID information for specifying a customer is first inserted into the information writer 201 (step 301). The ride 203 is then started to initiate an attraction (step 302) so that the camera 202 takes a park image including a customer (step 303). The information writer 201 records picture/video data including the park image onto the removable medium 102 (step 304). In this case, as the removable medium 102, a memory card having sufficient capacity to record the picture/video data is employed.

The receiver 103 receives contents for seeing and listening related to the attraction delivered from the broadcaster 104 (step 305). The receiver 103 reads the picture/video data recorded onto the removable medium 102, inserts the picture/video data into the contents (step 306) and plays a synthesis image thereof. This enables contents in which the audience himself/herself takes part to be seen and listened.

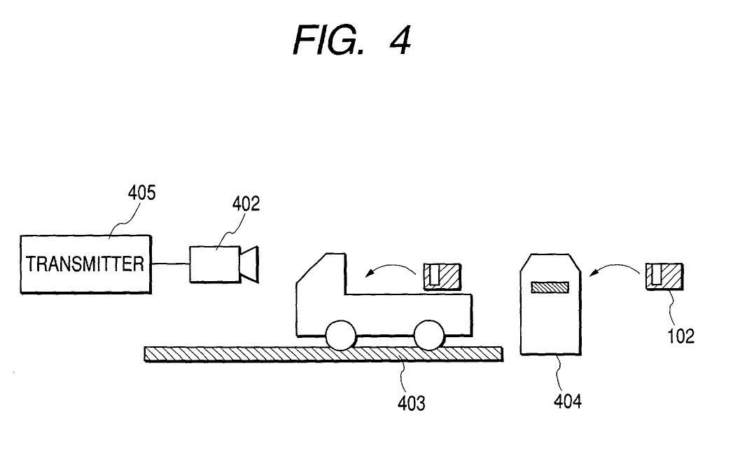

A second example of the attraction system 101 in this embodiment will be described using FIG. 4. The attraction system 101 has an information reader 404 for reading ID information for specifying a customer recorded onto the removable medium 102, a camera 402 for taking a park image, a transmitter 405 for transmitting the taken park image to the network 105, and a ride 403 a customer takes. The ride 403 can also be provided with the information reader 404. Other constructions are the same as those of the above-mentioned first example.

A second example of the service method in this embodiment will be described using FIGS. 1, 4 and 5. In this method, the information reader 404 first reads ID information for specifying a customer recorded onto the removable medium 102 (step 501). The ride 403 is then started (step 502). The camera 402 takes a customer-related park image (step 503). The transmitter 405 delivers picture/video data including the park image via the network 105 to the broadcaster 104 (step 504).

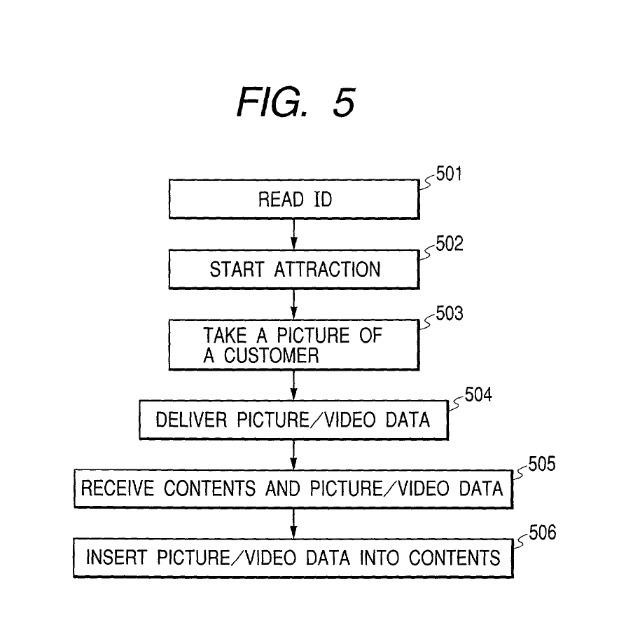

The receiver 103 receives the contents for seeing and listening related to the attraction and the picture/video data delivered in step 504, which are delivered from the broadcaster 104 (step 505). In this case, the receiver 103 reads ID information from the removable medium 102 to specify a customer and selects picture/video data to which the customer is related. The receiver 103 inserts the picture/video data into the received contents (step 506) to play a synthesis image thereof. This enables the contents in which the audience himself/herself takes part to be supplied for seeing and listening. A payment processing is performed to seeing and listening of contents and use of picture/video data, but the illustration of the process is omitted in FIG. 5.

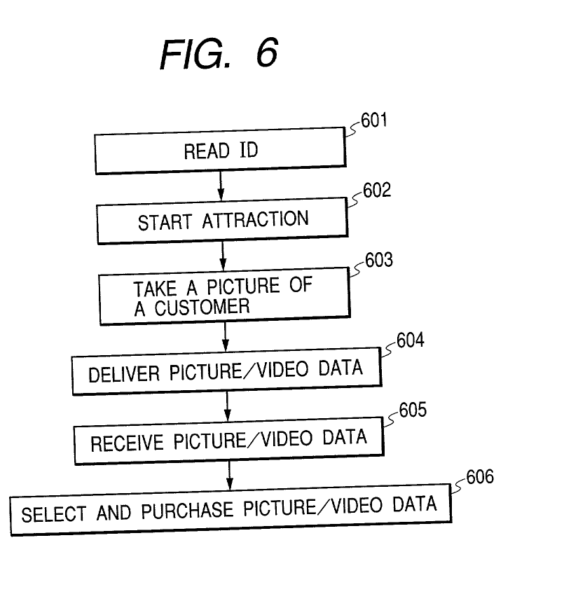

In the second example of the above-mentioned service, contents deliver is omitted, and only convenience possessed by the service method in which a customer easily browses and purchases a park image at home may be provided. The method is shown in FIG. 6. Steps 601 to 604 are respectively the same as steps 501 to 504 in the second example shown in FIG. 5. The receiver 103 receives picture/video data including a park image delivered from the broadcaster 104 in step 604 (step 605) , and a customer selects and purchases the data (step 606).

A picture provided in an attraction is typically printed on a print paper. Attempting to provide many kinds of pictures to each customer, an enormous browsing space must be prepared, making it difficult to realize such service supply. When attempting to take a video of a customer by a television camera, not by a picture, to record a moving image thereof onto videotape which is then supplied, taking back the videotape is inconvenient and costly. The method shown in FIG. 6 solves such inconvenience, whereby a customer can browse and purchase at home many kinds of images or moving images in an attraction park.

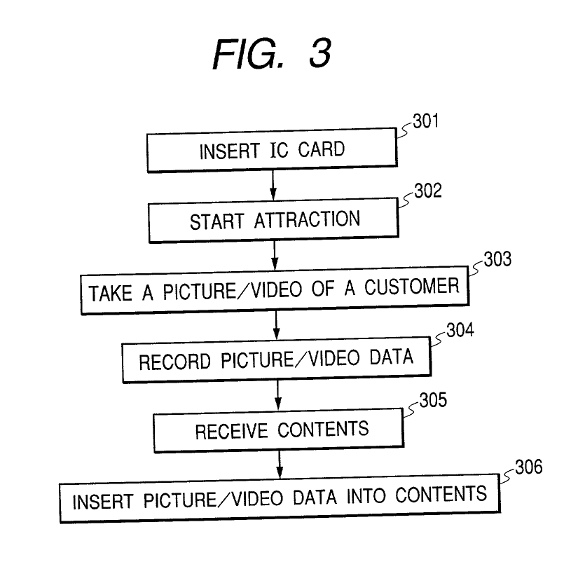

In the services shown in FIGS. 3, 5 and 6, the removable medium 102 are delivered to a customer at the initial contract related to the deliver, but may be delivered to the customer before he/she uses the attraction or may be previously provided in the receiver 103. A customer ID for specifying a customer read in the service methods shown in FIGS. 5 and 6 is recorded before delivering the removable medium 102, but the attraction system 101 may generate the ID information which is then written into the removable medium 102.

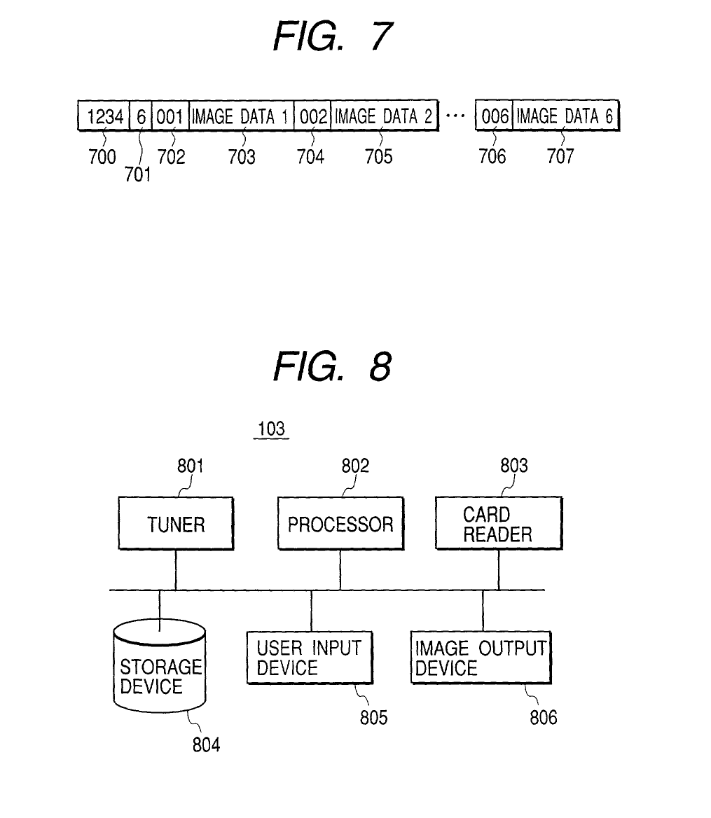

Prior to execution of step 306, an example of picture/video data read from the removable medium 102 will be described using FIG. 7. The picture/video data recorded onto the removable medium 102 has ID information (customer ID) 700 for specifying a customer, the number of park images 701, data IDs 702, 704 and 706 determined for each taken location or camera, and a set of a taken number of park images 703, 705 and 707. In FIG. 7, a customer ID is 1234, the number of taken park images is 6, and park images 1, 2, . . . , and 6 are respectively provided with 001, 002, . . . , and 006 as a data ID.

The picture/video data delivered from the broadcaster 104 in steps 504 and 604 are constructed as shown in FIG. 7. In the service method shown in FIG. 6, the data ID is not always required.

The construction example of the receiver 103 will be described using FIGS. 8, 3, 5 and 6. The receiver 103 has a receiving circuit (tuner) 801 for receiving the picture/video data (FIG. 7) and contents delivered from the broadcaster 104 by an electric wave, a processor 802 for performing a picture/video data reception processing of steps 505 and 605, a picture/video data selection and purchasing processing of step 606 and a data insertion processing into contents of steps 306 and 506, an information reader (card reader) 803 for reading data from the removable medium 102, a storage device 804 for storing the picture/video data, the contents and a program of the processing performed by the processor 802, a user input device 805 such as a remote controller, keyboard or mouse for performing a user input in the picture/video data selection and purchasing processing of step 605, and an image output device 806 such as a television monitor for displaying the contents or the picture/video data and displaying a user interface output of an interactive processing in the picture/video data selection and purchasing processing of step 605. When data deliver from the broadcaster 104 is performed via a broadband line, the tuner 801 is a network interface of the broadband line. When contents are supplied from a DVD, the tuner 801 is a DVD player.

When performing the service method shown in FIG. 3, the receiver 103 reads the picture/video data (FIG. 7) from the removable medium 102 prior to execution of step 306 and stores the read picture/video data into the storage device 804. At this time, when needed, the customer ID of a user of the receiver 103 is checked against the customer ID 700 included in the picture/video data.

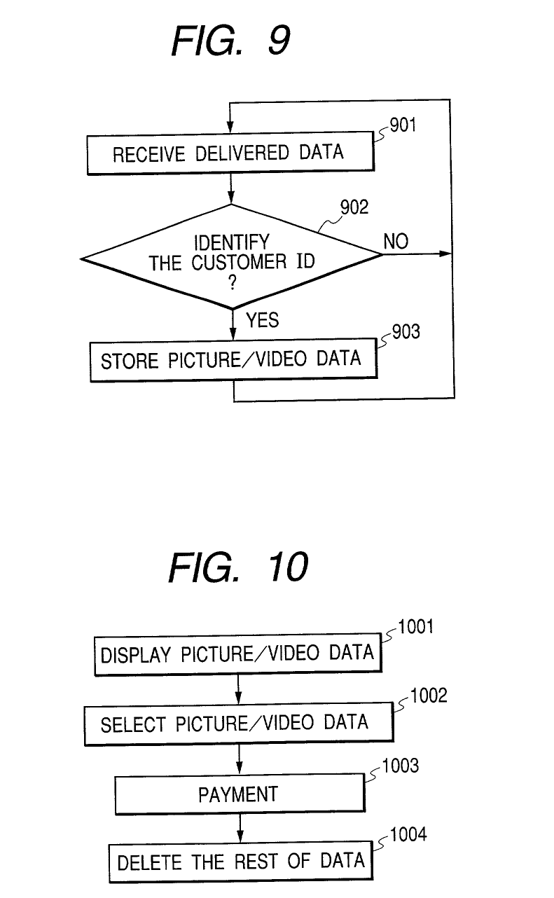

The picture/video data reception processing of steps 505 and 605 in the case of performing the service methods shown in FIGS. 5 and 6 will be described using FIGS. 9, 1, 7 and 8. The picture/video data (FIG. 7) delivered from the broadcaster 104 is first received by the tuner 801 (step 901). A customer ID read by the card reader 803 from another removable medium 102 which records only the customer ID, that is, a customer ID possessed by the receiver 103 is identified with the received customer ID 700 (step 902). When they are not identified with each other, the routine is returned to the delivered data reception processing of step 901. When they are identified with each other, the picture/video data 703, 705 and 707 are stored into the storage device 804 (step 903). In this manner, the picture/video data in which the customer IDs are identified with each other is captured into the receiver 103.

The picture/video data selection and purchasing processing of step 606 will be described using FIGS. 10, 7 and 8. The picture/video data 703, 705 and 707 stored into the storage device 804 are first displayed to the image output device 806 (step 1001). The user then uses the user input device 805 to select data to be purchased from the displayed picture/video data (step 1002). A payment processing corresponding to the selected data is performed (step 1003), so that the rest of picture/video data is deleted (step 1004). In the picture/video data selection processing of step 1002, when the user selects no picture/video data, the payment processing of step 1003 is not performed and all picture/video data are deleted.

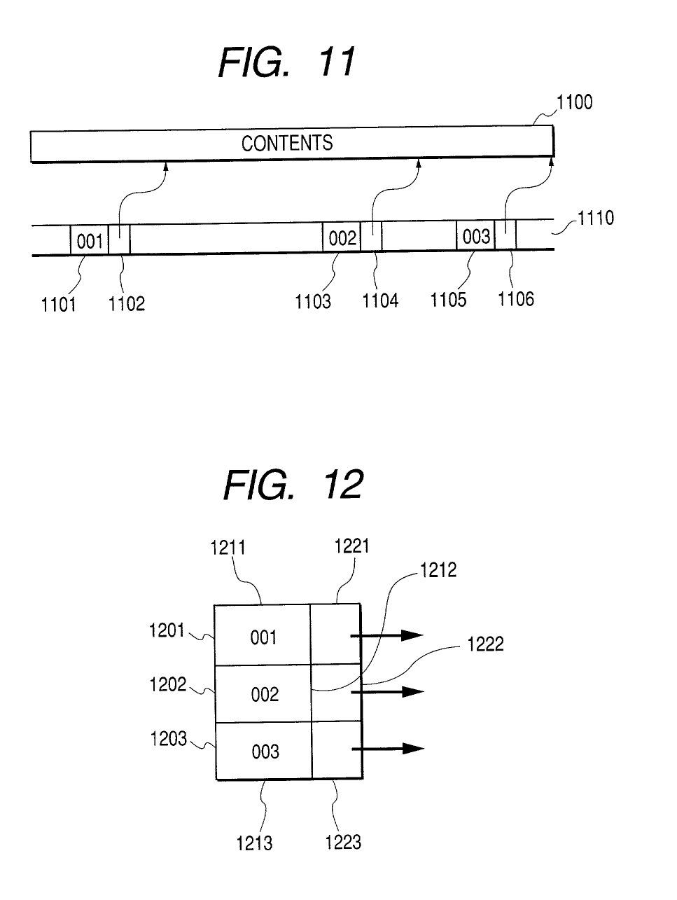

An example of image contents and related data delivered from the broadcaster 104 will be described using FIG. 11. Contents related information in this embodiment are multiplexed with the contents and delivered as a stream 1110 different from contents 1100 for seeing and listening. Related data has data IDs 1101, 1103 and 1105 of picture/video data inserted, and position information 1102, 1104 and 1106 in the contents into which the data are inserted. For example, FIG. 11 shows that picture/video data with ID =001 is inserted into the first half of the contents, picture/video data with ID =002 is inserted into the latter half thereof, and the data with ID =003 is inserted immediately after the end of the contents. Here, the position information is represented by relative time or the number of frames in the contents. Related information is sent with the contents at the same time, but can be sent separately from the contents. When part of contents is played with real time, related data having position information in the part is delivered before the corresponding part of the contents. When it is not played with real time, related data is delivered before playing the part of the contents corresponding to the position information 1102, 1104 and 1106 pointed by the related data.

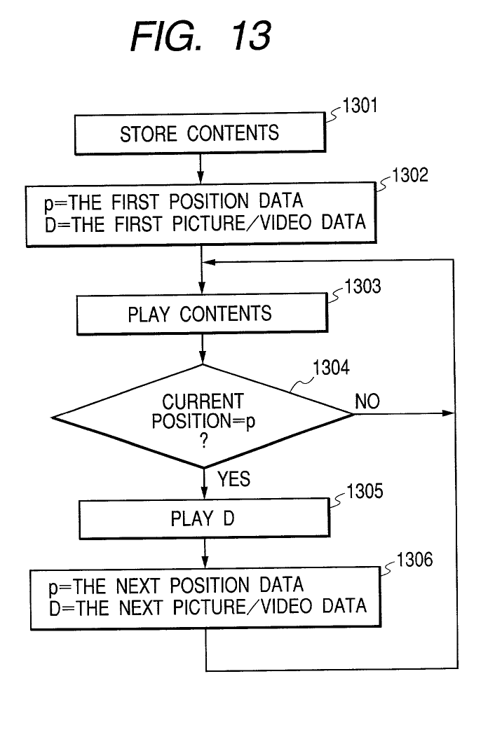

The picture/video data insertion processing to the contents of steps 306 and 506 will be described using FIGS. 12, 13, 7, 8 and 11. The following processing is performed by the processor 802 in accordance with the program stored into the storage device 804. The delivered contents 1100 inputted from the tuner 801 are recorded into the storage device 804 together with the related data 1101 to 1106 (step 1301). At this time, related data are stored in forms of 1201 to 1203.

When the user uses the user input device 805 to command play, the first position information 1221 is substituted into a variable p, and the picture/video data 703 corresponding to the data ID 702 equal to the first data ID 1211 is substituted into a variable D (step 1302). The contents are started to play (step 1303) , and when the play position of the contents is before p, the play is continued (step 1304). When the play position of the contents becomes p, the picture/video data D is played (step 1305). The next position information 1222 is substituted into p, and the picture/video data 705 corresponding to the data ID 704 equal to the next data ID 1212 is substituted into D (step 1306). The play of the contents of step 1303 is restarted. The above processing is continued until the play of the contents is ended.

The above processing can supply, to a customer visiting an attraction, a service for inserting a park image related to the customer into a story of contents related to the attraction.

When the attraction 101 has only the ride 203 and the information writer 201, after starting the attraction of step 302, in place of the processing for recording picture/video data of step 304, a use history of the number of attraction uses may be recorded onto the removable medium 102 using the information writer 201. When contents are seen and listened by the receiver 103, the attraction use history recorded onto the removal medium 102 is read from the card reader 803. When the use history exists, a privilege service is supplied to a customer such that privilege contents different from typical ones can be seen and listened or a contents seeing and listening fee is discounted according to the number of uses.

The present invention can supply, to a customer who has used an attraction, a service such that the customer can see and listen to contents in which he/she takes part and enjoy them. This enables a contents provider to induce a customer who has used an attraction to actively see and listen to contents. In addition, the customer can browse and purchase at home many kinds of images or moving images during attraction use.

While the present invention has been described above in conjunction with the preferred embodiments, one of ordinary skill in the art would be enabled by this disclosure to make various modifications to this embodiment and still be within the scope and spirit of the invention as defined in the appended claims.

What is claimed is:

1. A method of cooperation service with attraction and seeing and listening of contents comprising: taking a park image to which a customer during attraction use is related; capturing the taken park image into a receiver; and inserting the park image into contents related to the attraction, the contents being supplied for seeing and listening by using the receiver.

2. A method of cooperation service with attraction and seeing and listening of contents comprising: taking a park image to which a customer during attraction use is related; recording the taken park image onto a portable recording medium; reading the park image recorded onto the portable recording medium to capture the park image into a receiver; and inserting the park image into contents related to said attraction, the contents being supplied for seeing and listening by using the receiver.

3. A portable recording medium used in the method of cooperation service with attraction and seeing and listening of contents of claim 2, wherein a taken park image to which a customer during attraction use is related is recorded.

4. A method of cooperation service with attraction and seeing and listening of contents comprising the steps of: taking a park image to which a customer during attraction use is related; transmitting the taken park image to a broadcaster; delivering the received park image and contents related to said attraction from the broadcaster; receiving the delivered park image and the delivered contents by a receiver; and inserting the received park image into the contents that are supplied for seeing and listening by using the receiver, wherein the park image has a customer ID identified with a customer ID (identifier) possessed by the receiver.

5. A method of cooperation service with attraction and seeing and listening of contents comprising: recording an attraction use history of a customer onto a portable recording medium; reading the attraction use history recorded onto the portable recording medium by a receiver; and supplying to said customer a privilege service corresponding to the attraction use history when seeing and listening to contents related to said attraction, the contents being supplied for seeing and listening by using the receiver.

6. An attraction system for executing an attraction used in the method of cooperation service with attraction and seeing and listening of contents of claim 5, comprising: at least an information writer which records an attraction use history of a customer onto a portable recording medium.
